(19) United States
(12) Patent Application Publication
(10) Pub. No.: US 2017/0104415 A1
(43) Pub. Date: Apr. 13, 2017

(54) SWITCHED-MODE VOLTAGE CONVERTER

(71) Applicant: MStar Semiconductor, Inc., Hsinchu Hsien (TW)

(72) Inventors: Guo-Kiang HUNG, Zhubei City (TW); Ming-Sen CHENG, Zhubei City (TW)

(21) Appl. No.: 14/988,942

(22) Filed: Jan. 6, 2016

(30) Foreign Application Priority Data
Oct. 7, 2015 (TW) 104133018

(51) Int. Cl. H02M 3/158; H02M 1/44

(52) U.S. Cl. CPC H02M 3/158; H02M 1/44

(57) ABSTRACT

A switched-mode voltage converter includes an energy storage component, a plurality of switches and a controller. The energy storage component is coupled to a voltage source, and includes a switching terminal. The plurality of switches are coupled between the switching terminal of the energy storage component and a circuit node. The controller is configured to control the plurality of switches, such that switching terminal of the energy storage unit is intermittently coupled to the circuit node. Further, the controller controls the plurality of switches to switch from a first connecting state to a second connecting state at different time points.

This application claims the benefit of Taiwan application Serial No. 104133018, filed Oct. 7, 2015, the subject matter of which is incorporated herein by reference.

### BACKGROUND OF THE INVENTION

Field of the Invention

The invention relates in general to a voltage converter, and more particularly, to a technology capable of reducing high-frequency electromagnetic interference (EMI) in a switched-mode voltage converter.

Description of the Related Art

In general, an external power supply or an internal power storage component of an electronic device supplies only a constant voltage. If there are circuits that are driven by two or more different voltages in an electronic device, the electronic device needs to include a direct-current to direct-current (DC-DC) voltage converter. A switched-mode power supply, having preferred conversion efficiency compared to a linear regulator, is extensively applied in devices that require DC-DC voltage conversion.

Based on the relativity of an output voltage and an input voltage, DC-DC voltage supplies may be categorized into two types—boost converters and buck converters. FIG. 1(A) and FIG. 1(B) are typical functional block diagrams of these two types of converters, respectively. A common feature of these two circuits is that, electric energy in an energy storage component (an inductor L) is transferred by periodically switching a switch S. A voltage value of a converted voltage V_{OUT} relative to the that of a non-converted voltage V_{DD} is associated with turned-on/turned-off periods set for the switch S, and may be determined according to actual requirements of loads 110 and 120. An issue of a current switched-mode voltage converter is that, at an instant at which the switch S is switched from a turned-off state to a turned-on state, or at an instant at which the switch S is switched from a turned-on state to a turned-off state, a significant current change occurs in both currents I_{VDD} and I_{GND} that enter or exit the voltage converter. As a result, high-frequency electromagnetic interference (EMI) is brought upon peripheral circuits of the voltage converter and the loads 110 and 120 that utilizes the converted voltage V_{OUT}.

### SUMMARY OF THE INVENTION

The invention is directed to a switched-mode voltage converter for solving the above issue of high-frequency EMI.

A switched-mode voltage converter is provided according to an embodiment of the present invention. The switched-mode voltage converter includes an energy storage component, a plurality of switches and a controller. The energy storage unit is coupled to a voltage source, and includes a switching terminal. The plurality of switches are coupled between the switching terminal of the energy storage component and a circuit node. The controller is configured to switch the plurality of switches, such that the switching terminal of the energy storage component is intermittently coupled to the circuit node. Further, the controller controls the plurality of switches to switch from a first connecting state to a second connecting state at different time points.

A switched-mode voltage converter is provided according to another embodiment of the present invention. The switched-mode voltage converter includes an energy storage component, a switch and a controller. The energy storage component is coupled to a voltage source, and includes a switching terminal. The switch is coupled between the switching terminal of the energy storage component and a circuit node. The controller is configured to switch the switch, such that the switching terminal of the energy storage component is intermittently coupled to the circuit node. Further, the controller outputs a spread spectrum signal to control a switching time point of the switch.

A switched-mode voltage converter is further provided according to another embodiment of the present invention. The switched-mode voltage converter includes an energy storage component, a switch, a controller, and a slew rate control module. The energy storage component is coupled to a voltage source, and includes a switching terminal. The switch is coupled between the switching terminal of the energy storage component and a circuit node. The controller generates a control signal for the switch. The slew rate control module is coupled between the switch and the controller, and is configured to generate a switch control signal according to the control signal, such that the switch control signal has a lower slew rate compared to the control signal. The switch is controlled by the switch control signal, such that the switching terminal of the energy storage component is intermittently coupled to the circuit node.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) and FIG. 1(B) are typical block diagrams of a switched-mode boost converter and a switched-mode buck converter, respectively;

FIG. 2(A) is a block diagram of a switched-mode boost converter according to an embodiment of the present invention; FIG. 2(B) to FIG. 2(D) are exemplary timing diagrams of control signals in the boost converter;

FIG. 2(E) is a control signal generating circuit that can be adopted in a voltage converter according to the present invention;

FIG. 3(A) to FIG. 3(C) are block diagrams of several spread spectrum signal generating circuits;

FIG. 4(A) is a block diagram of a switched-mode boost converter according to an embodiment of the present invention; FIG. 4(B) is an exemplary timing diagram of control signals in the boost converter;

FIG. 5 shows a switched-mode buck converter according to an embodiment applying the concept of the present invention;

FIG. 6 is a block diagram of a switched-mode boost converter according to another embodiment of the present invention;

FIG. 7(A) is a block diagram of a switched-mode boost converter according to another embodiment of the present invention; FIG. 7(B) is an exemplary timing diagram of control signals in the boost converter;

FIG. 8(A) is a block diagram of a switched-mode boost converter according to another embodiment of the present invention; FIG. 8(B) is an exemplary timing diagram of control signals in the boost converter.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

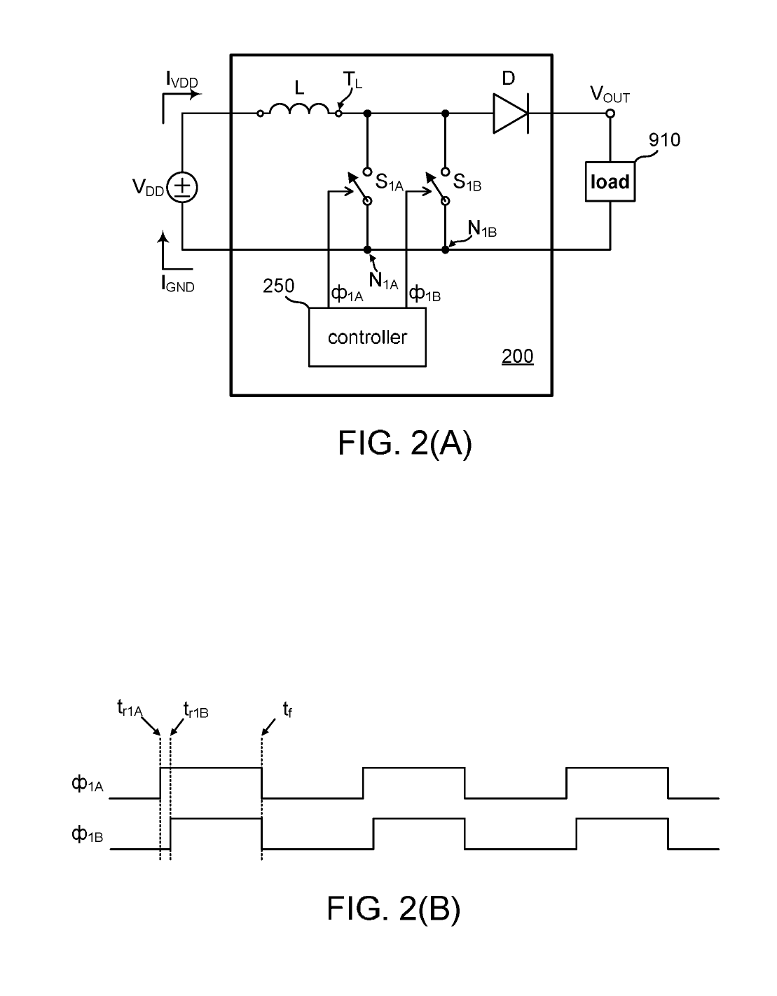

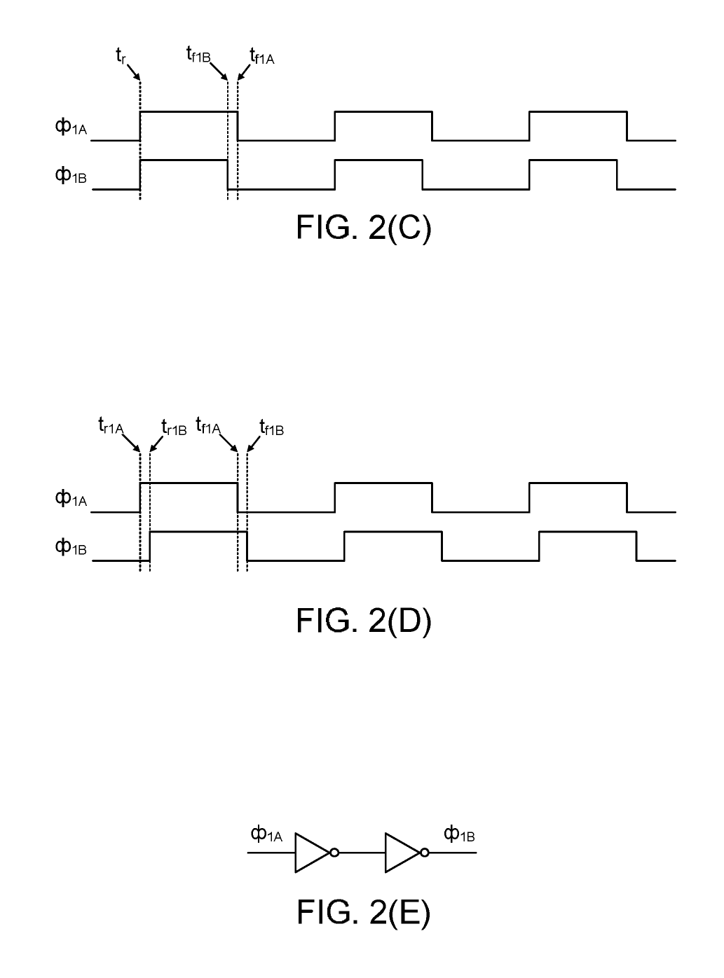

The concept of the present invention is applicable to various types of switched-mode voltage converters. A boost converter according to an embodiment applying the concept of the present invention is described below. FIG. 2(A) shows a block diagram of a boost converter 200 according to an embodiment. The boost converter 200 includes an energy storage component (an inductor L), a diode D, a plurality of switches (two switches S_{1A} and S_{1B} are taken as an example in the embodiment), and a controller 250. The boost converter 200 receives an voltage V_{DD}, and provides a boosted voltage V_{OUT} to a load 910. The voltage V_{DD} may be provided by a power supply, or may be provided by a power generator. More specifically, the power generator may be an analog circuit. For example, the analog circuit is a low drop-out (LDO) regulator.

The inductor L includes a switching terminal T_{L}. The switch S_{1A} is coupled between the switching terminal T_{L} and a circuit node N_{1A}, and the switch S_{1B} is coupled between the switching terminal T_{L} and a circuit node N_{1B}. As seen from FIG. 2(A), the circuit nodes N_{1A} and N_{1B} are in fact the same circuit node (to be referred to as a circuit node N). Thus, the switches S_{1A} and S_{1B} may be regarded as being connected in parallel between the switching terminal T_{L} of the inductor L and the circuit node N. The switches S_{1A} and S_{1B} are controlled by signals Φ_{1A} and Φ_{1B} that the controller 250 generates. The controller 250 is in charge of switching the switches S_{1A} and S_{1B}, such that the switching terminal T_{L} of the inductor L is intermittently coupled to the circuit node N.

Assume that the switches S_{1A} and S_{1B} are turned on when the control signals Φ_{1A} and Φ_{1B} have a high voltage level, and are turned off when the Φ_{1A} and Φ_{1B} have a low voltage level. FIG. 2(B) shows an exemplary timing diagram of the control signals Φ_{1A} and Φ_{1B}. In this example, each of the control signals Φ_{1A} and Φ_{1B} is a square wave signal. Most of the time, the control signals Φ_{1A} and Φ_{1B} are simultaneously at a high voltage level or simultaneously at a low voltage level. However, a time point t t_{r1A} at which each rising edge of the control signal Φ_{1A} appears is slightly earlier than a time point t_{r1B} at which each rising edge of the control signal Φ_{1B} appears. In other words, the controller 250 controls the switches S_{1A} and S_{1B} to switch from a turned-off state to a turned-on state at different time points. On the other hand, time points at which falling edges of the control signals Φ_{1A} and Φ_{1B} are substantially the same (e.g., a time point t_{f}).

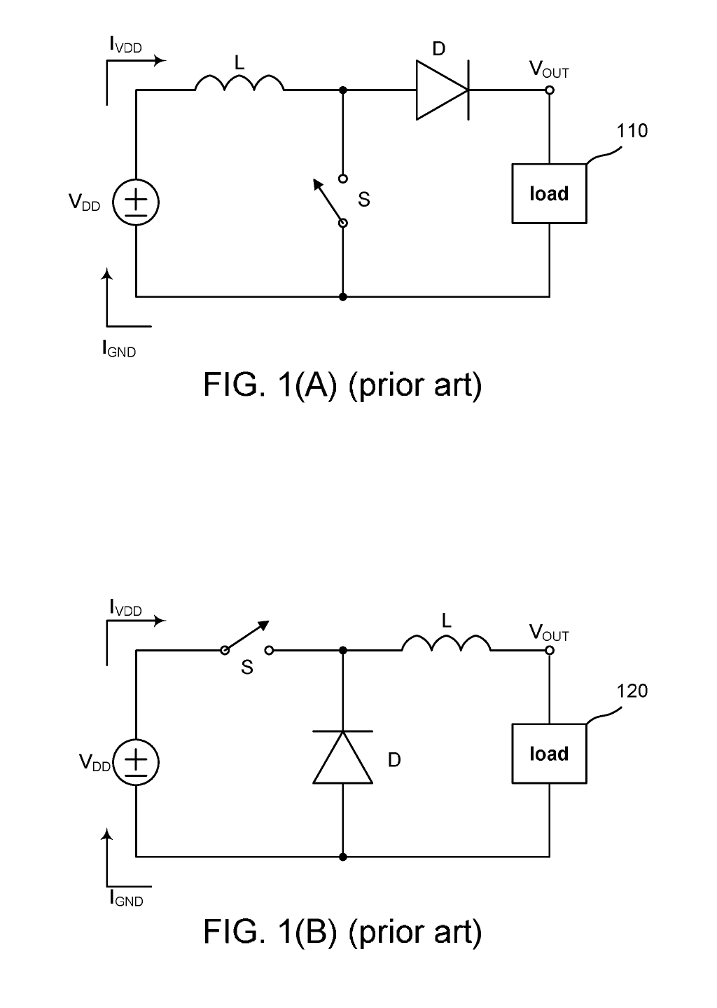

When a turned-on/off state of a switch is switched, the magnitude of an instantaneous current change caused is directly proportional to a current driving capability of the switch. In one embodiment, to reduce the instantaneous current changes when the switches S_{1A} and S_{1B} are switched, the current driving capabilities of the switches S_{1A} and S_{1B} (i.e., the amounts of currents that help charging/discharging the switching terminal T_{L}) are designed to be lower than a predetermined threshold. As generally known to one person skilled in the art, the intensity of EMI gets larger as the magnitude of instantaneous current changes gets larger. In practice, the predetermined threshold may be determined by a circuit designer according to simulation results and practical experiences associated with EMI tests. For example, assuming that the switch S in FIG. 1(A) and the switches S_{1A} and S_{1B} are implemented by metal oxide semiconductor field effect transistors (MOSFETs), the transistor sizes of the switches S_{1A} and S_{1B} can be designed to be one half of that of the switch S, with however a sum of the current driving capabilities of the switches S_{1A} and S_{1B} being substantially equal to that of the switch S. Assuming that other conditions are the same, the instantaneous current change that discharges the switching terminal T_{L} when the switch S_{1A} enters a turned-on state is apparently lower than the instantaneous current change caused by the switch S entering a turned-on state. Further, the instantaneous current change brought by the switch S_{1B} later entering a turned-on state is lower than the instantaneous current change caused by the switch S entering a turned-on state. By distributing the instantaneous current change that discharges the switching terminal T_{L}, excessively large current changes in the current I_{VDD} and I_{GND} entering or exiting the boost converter 200 are prevented. Thus, the EMI caused by the switches S_{1A} and S_{1B} is controlled to be smaller than the EMI caused by the current change of the switch S in FIG. 1(A).

It should be noted that, the number of switches included in the boost converter 200 and the current driving capabilities of these switches are not limited to the above examples. For example, the boost converter 200 may include three switches, each of which having a current driving capability that is one-third of that of the switch S. For another example, the driving capabilities of the two switches S_{1A} and S_{1B} of the boost converter 200 may be designed to be four-fifth or one-fifth of that of the switch S, respectively. In other words, the current driving capabilities of the plurality of switches may be equal or different. Given that the sum of the current driving capabilities of all the switches is sufficient for completing the transfer of electric energy in the inductor L within a predetermined time limit, EMI can be reduced without degrading the boost effect of the boost converter 200. In practice, the time limit is associated with the converted voltage stability demanded in the design specifications of the boost converter 200. Further, the switches S_{1A} and S_{1B} may be implemented by one single transistor or a transmission gate formed by two transistors, and are not limited to MOSFETs.

FIG. 2(C) shows another exemplary timing diagram of the control signals Φ_{1A} and Φ_{1B}. In this example, a time point t_{f1A} at which each falling edge of the control signal Φ_{1A} appears is slightly later than a time point t_{f1B} at which each falling edge of the control signal Φ_{1B} appears. In other words, the controller 250 controls the switches S_{1A} and S_{1B} to switch from a turned-on state to a turned-off state at different time points. On the other hand, time points at which rising edges of the control signals Φ_{1A} and Φ_{1B} are substantially the same (e.g., a time point tᵣ). Similarly, such voltage timing relationship helps distributing the instantaneous current change caused when the switches S_{1A} and S_{1B} stop discharging the switching terminal T_{L}, thereby reducing the EMI.

FIG. 2(D) shows yet another exemplary timing diagram of the control signals Φ_{1A} and Φ_{1B}. In this example, a time point t_{r1A} at which each rising edge of the control signal Φ_{1A} appears is slightly earlier than a time point t_{r1B} at which each rising edge of the control signal Φ_{1B} appears, and a time point t_{f1A} at which each falling edge of the control signal Φ_{1A} appears is also slightly earlier than a time point t_{f1B} at which each falling edge of the control signal Φ_{1B} appears. Compared to the control signals in FIG. 2(B) and FIG. 2(C), the time points at which more than one group of control signals Φ_{1A} and Φ_{1B} in FIG. 2(D) are distributed, thereby further reducing the EMI.

In practice, the controller 250 may include a delay component formed by two inverters, as shown in FIG. 2(E). A control signal obtained from inputting the control signal Φ_{1A} into the delay component may serve as the control signal Φ_{1B}, with a timing relationship between the two control signals as shown in FIG. 2(D). One person ordinary skilled in the art can understand that, there are many other circuit configurations and elements capable of realizing the concept of the present invention without departing from the spirit of the present invention. It should be noted that, the amount of signal delay contributed by the delay component (i.e., a transition time difference of the control signals Φ_{1A} and Φ_{1B}) may be determined by a circuit designer.

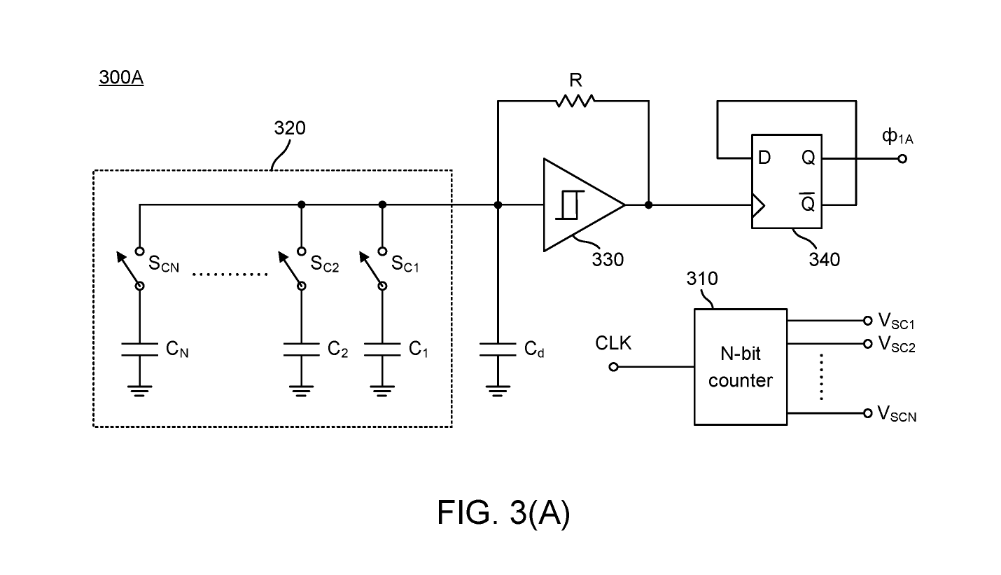

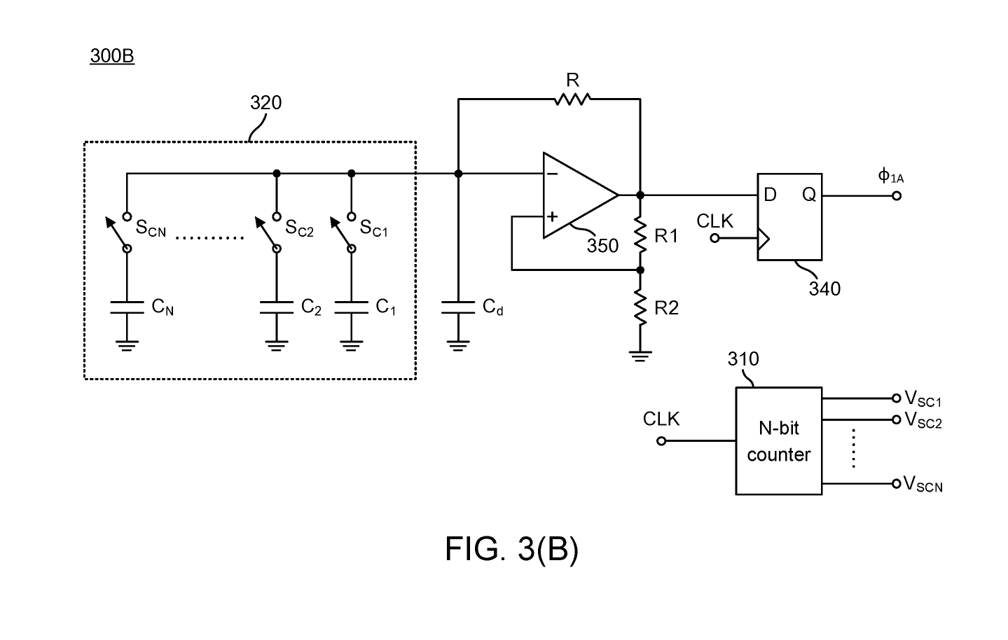

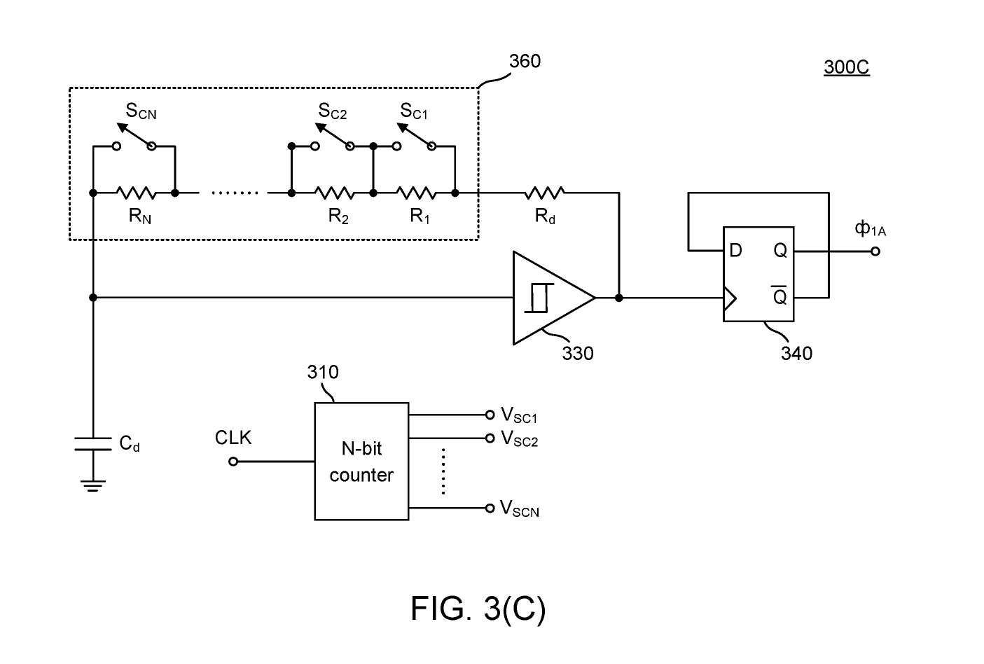

In one embodiment, the controller 250 adopts a spread spectrum signal as the control signal Φ_{1A} and/or the control signal Φ_{1B}. FIG. 3(A) shows a block diagram of a spread spectrum signal generating circuit. A spread spectrum signal generating circuit 300A includes an N-bit counter 310, an N-bit capacitor array 320, a Schmitt trigger 330, a D flip-flop 340, a feedback resistor R and a predetermined capacitor C_{d}, where N is an integer greater than 1. The N-bit counter 310 constantly changes a counter result (e.g., counting forward starting from 0 till 2^{N}−1 and counting forward again starting from 0) according to a clock signal CLK, and outputs N control voltages V_{SC1}, V_{SC2}, . . . , and V_{SCN} corresponding to the counter result. Each of the control voltages may correspond to one bit of the N bits. The N control voltages are utilized to control N switches S_{C1}, S_{C2}, . . . , and S_{CN} in the N-bit capacitor array 320, so as to selectively couple N capacitor C₁, C₂, . . . , and C_{N} in the N-bit capacitor array 320 to an input end of the Schmitt trigger 330 to become capacitors connected in parallel with the predetermined capacitor C_{d}. All of the capacitors coupled to the input end of the Schmitt trigger 330 are collectively referred to as a summed capacitance C_{SUM}, which has a capacitance value that changes correspondingly to the control signal outputted from the N-bit counter 310. In FIG. 3(A), the connection between the Schmitt trigger 330 and the D flip-flop 340 causes the control signal Φ_{1A} to become a constantly oscillating periodic square wave signal, and the period of the control signal Φ_{1A} is directly proportional to a product of the feedback resistor R and the summed capacitance C_{SUM}. As the summed capacitance C_{SUM} constantly changes, the period of the control signal Φ_{1A} also continuously changes within a controllable range. Thus, the control signal Φ_{1A} becomes a spread spectrum signal.

FIG. 3(B) shows a block diagram of another spread spectrum signal generating circuit. A spread spectrum signal generating circuit 300B includes an N-bit counter 310, an N-bit capacitor array 320, a D flip-flip 340, an operational amplifier 350, three resistors (R, R1 and R2), and a predetermined capacitor C_{d}. In FIG. 3(B), operations of the N-bit counter 310 and the N-bit capacitor array 320 may be similar to those shown in FIG. 3(A), and shall be omitted herein. By changing connections of the switches in the N-bit capacitor array 320, the signal Φ_{1A} generated by the spread spectrum signal generating circuit 300B may be a spread spectrum signal. For example, assuming that the resistance value of the predetermined capacitor C_{d} is equal to CX and N is equal to 4, the capacitance values C₁, C₂, C₃ and C₄ may be designed to be equal to 0.01CX, 0.02CX, 0.04CX and 0.08CX, respectively. Compared to a situation where all of the switches in the capacitor array 320 are switched to be turned off, when all of the switches in the capacitor array 320 are switched to be turned on, the total capacitance value connected to the input end of the Schmitt trigger 330 is increased to 1.15CX, hence leading to an increased period of the control signal Φ_{1A} and reducing the frequency of the signal Φ_{1A}.

FIG. 3(C) shows a block diagram of another spread spectrum signal generating circuit. A spread spectrum signal generating circuit 300C includes an N-bit counter 310, a Schmitt trigger 330, a D flip-flip 340, an N-bit resistor array 360, a predetermined resistor R_{d}, and a predetermined capacitor C_{d}. Similarly, the N-bit counter 310 controls N switches S_{C1}, S_{C2}, . . . , and S_{CN} in the N-bit resistor array 360, so as to allow N resistors R₁, R₂, . . . , and RN in the N-bit resistor array 360 to be selectively connected to the predetermined resistor R_{d}. By changing the connections of the switches in the N-bit resistor array 360, the signal Φ_{1A} generated by the spread spectrum signal generating circuit 300C may be a spread spectrum signal. For example, assuming that the value of the predetermined resistance value R_{d} is equal to RX and N is equal to 4, the resistance values R₁, R₂, R₃ and R₄ may be designed to be equal to 0.01RX, 0.02RX, 0.04RX and 0.08RX, respectively. Compared to a situation where all of the switches in the resistor array 360 are switched to be turned on, when all of the switches in the resistor array 360 are switched to be turned off, the total resistance value connected between the input end and the output end of the Schmitt trigger 330 is increased to 1.15RX, hence leading to an increased period of the control signal Φ_{1A} and reducing the frequency of the signal Φ_{1A}.

Spread spectrum signals are characterized by the capability of distributing EMI energy of a specific frequency. Thus, by controlling the switching time point(s) of the switch S_{1A} and/or the switch S_{1B}, the effect of reducing high-frequency EMI can also be achieved. In practice, the modulation period, frequency hopping rule or degree of spread spectrum may or may not change with time. Even if the control signal Φ_{1A} and/or the control signal Φ_{1B} is a spread spectrum signal instead of a square wave signal having a constant period, given the sum of the current driving capabilities of the switches S_{1A} and S_{1B} is sufficient for completing transferring the electric energy of the inductor L within a predetermined time limit, high-frequency EMI can be reduced without degrading the boost effect of the boost converter 200. One person skilled in the art can understand that, there are various other methods for generating spread spectrum signals, and the scope of the present invention is not limited to the examples described above.

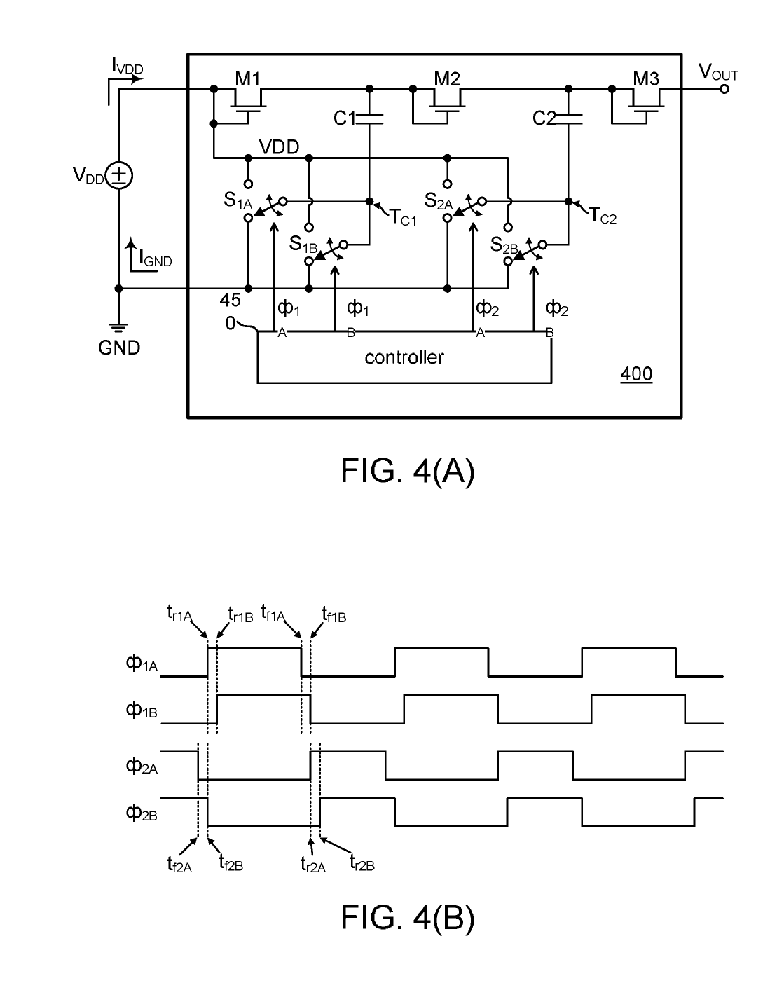

FIG. 4(A) shows another boost converter according to another embodiment applying the concept of the present invention. A boost converter 400 includes two energy storage components (capacitors C₁ and C₂), three diodes (M₁, M₂ and M₃) implemented by MOSFETs, four switches (S_{1A}, S_{1B}, S_{2A} and S_{2B}), and a controller 450. The boost converter 400 receives a voltage V_{DD}, and outputs a boosted voltage V_{OUT}. The capacitor C1 includes a switching terminal T_{C1}, and the capacitor C2 includes a switching terminal T_{C2}. The switches S_{1A} and S_{1B} are coupled between the switching terminal T_{C1} of the capacitor C1, the voltage supply terminal VDD and the ground terminal GND. The switches S_{2A} and S_{2B} are coupled between the switching terminal T_{C2} of the capacitor C2, the voltage supply terminal VDD and the ground terminal GND. By changing connection targets of the switching terminals T_{C1} and T_{C2} to transfer the electric energy in the capacitor C1 and C2, the boosted voltage V_{OUT} is substantially equal to (3*V_{DD}−3*Vₜₕ), where Vₜₕ represents a threshold voltage of the transistors M1 to M3.

In one embodiment, switches S_{1A}, S_{1B}, S_{2A} and S_{2B} are controlled by signals Φ_{1A}, Φ_{1B}, Φ_{2A} and Φ_{2B} that are generated by the controller 450 and driving capabilities of the switches S_{1A}, S_{1B}, S_{2A} and S_{2B} are lower than a predetermined threshold. Assume that switching terminals T_{C1} and T_{C2} are connected to the power supply terminal VDD when the control signals Φ_{1A}, Φ_{1B}, Φ_{2A} and Φ_{2B} have a high voltage level, and are connected to the ground terminal GND when the control signals Φ_{1A}, Φ_{1B}, Φ_{2A} and Φ_{2B} have a low voltage level. FIG. 4(B) shows an exemplary timing diagram of the control signals Φ_{1A}, Φ_{1B}, Φ_{2A} and Φ_{2B}. In this example, the time point t_{r1A} at which each rising edge of the control signal Φ_{1A} appears is slightly earlier than the time point t_{r1B} at which each rising edge of the control signal Φ_{1B} appears, and the time point t_{f1A} at which each falling edge of the control signal Φ_{1A} appears is also slightly earlier than the time point Φ_{1B} at which each falling edge of the control signal Φ_{1B} appears. On the other hand, the time point t_{r2A} at which each rising edge of the control signal Φ_{2A} appears is slightly earlier than the time point t_{r2B} at which each rising edge of the control signal Φ_{2B} appears, and the time point t_{f2A} at which each falling edge of the control signal Φ_{2A} appears is also slightly earlier than the time point t_{f2B} at which each falling edge of the control signal Φ_{2B} appears.

It is seen from FIG. 4(B) that, the control signals provided to the switches S_{1A} and S_{1B} and the control signals provided to the switches S_{2A} and S_{2B} are substantially non-overlapping signals. The controller 450 controls the switches S_{1A} and S_{1B} to be switched from a first connecting state (connected to the voltage supply terminal VDD) to a second connecting state (connected to the ground terminal GND) at different time points, and also controls the switches S_{1A} and S_{1B} to be switched from the second connecting state to the first connecting state at different time points. Similarly, the controller 450 controls the switches S_{2A} and S_{2B} to be switched from the first connecting state (connected to the voltage supply terminal VDD) to the second connecting state (connected to the ground terminal GND) at different time points, and also controls the switches S_{2A} and S_{2B} to be switched from the second connecting state to the first connecting state at different time points. As previously stated, the current driving capabilities of the switches S_{1A}, S_{1B}, S_{2A} and S_{2B} are designed to be lower than a predetermined threshold. Coordinated with the voltage timing relationship in FIG. 4(B), the instantaneous current changes of the currents I_{VDD} and I_{GND} entering or exiting the boost converter 400 can be effectively lowered, thereby reducing the high-frequency EMI generated.

In another embodiment, the switches S_{1A}, S_{1B}, S_{2A} and S_{2B} in FIG. 4(A) are controlled by the control signals Φ_{1A}, Φ_{1B}, Φ_{2A} and Φ_{2B} generated by the controller 450, and the control signals Φ_{1A}, Φ_{1B}, Φ_{2A} and Φ_{2B} are spread spectrum signals generated by the controller 450. For example, the controller 450 may include the spread spectrum signal generating circuit in FIG. 3(A), and such details shall be omitted herein.

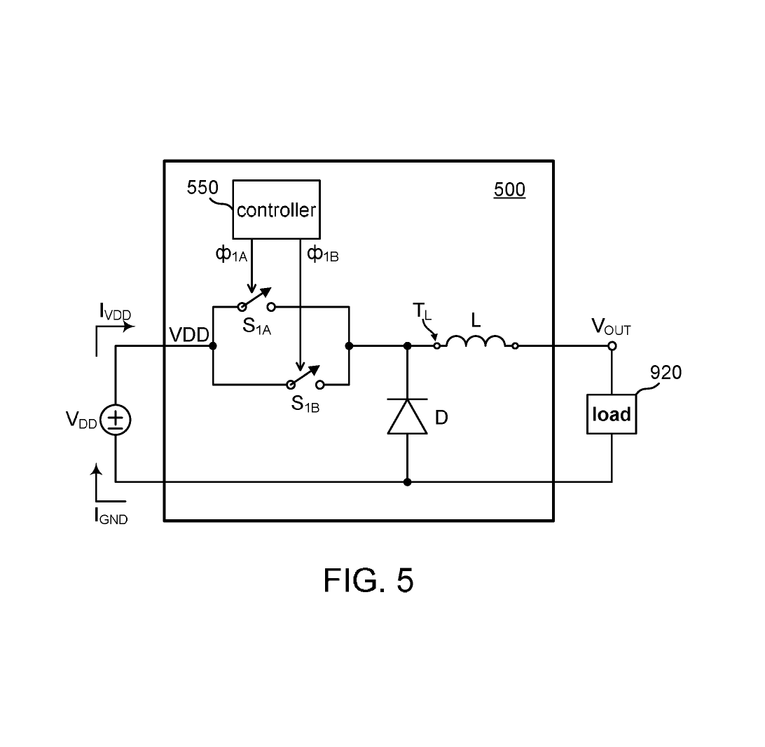

FIG. 5 shows a switched-mode buck converter according to an embodiment applying the concept of the present invention. A buck converter 500 includes an energy storage component (an inductor L), a diode D, a plurality of switches (two switches S_{1A} and S_{1B} are taken as an example in this embodiment), and a controller 550. The buck converter 500 receives a voltage V_{DD}, and provides a bucked voltage V_{OUT} to a load 920. The inductor L has a switching terminal T_{L}. The switches S_{1A} and S_{1B} are coupled in parallel between the switching terminal T_{L} and a power supply terminal VDD, and are controlled by the signals Φ_{1A} and Φ_{1B} generated by the controller 550. The controller 550 is in charge of switching the switches S_{1A} and S_{1B}, such that the switching terminal T_{L} of the inductor L is intermittently coupled to the power supply terminal VDD. Most of the time, the switches S_{1A} and S_{1B} are simultaneously turned on or simultaneously turned off. Similar to the boost converters described in previous embodiments, by having the current driving capabilities of the switches S_{1A} and S_{1B} be lower than a predetermined threshold and controlling the switches S_{1A} and S_{1B} to be switched from a first connecting state to a second connecting state at different time points, the buck converter 500 achieves the effect of reducing high-frequency EMI.

It should be noted that, basic operation principles of the boost converters 200 and 400 as well as the buck converter 500 (e.g., how boosting/bucking effects are achieved) are generally known to one person having ordinary skill in the art, and shall be omitted herein. Further, one person having ordinary skill in the art can understand that, operations and variations in the description associated with the boost converter 200 (e.g., modifying the number of switches, changing the ratios of the driving capabilities of the switches, and adopting spread spectrum signals) are applicable to the boost converter 400 and the buck converter 500, and such details shall be omitted herein.

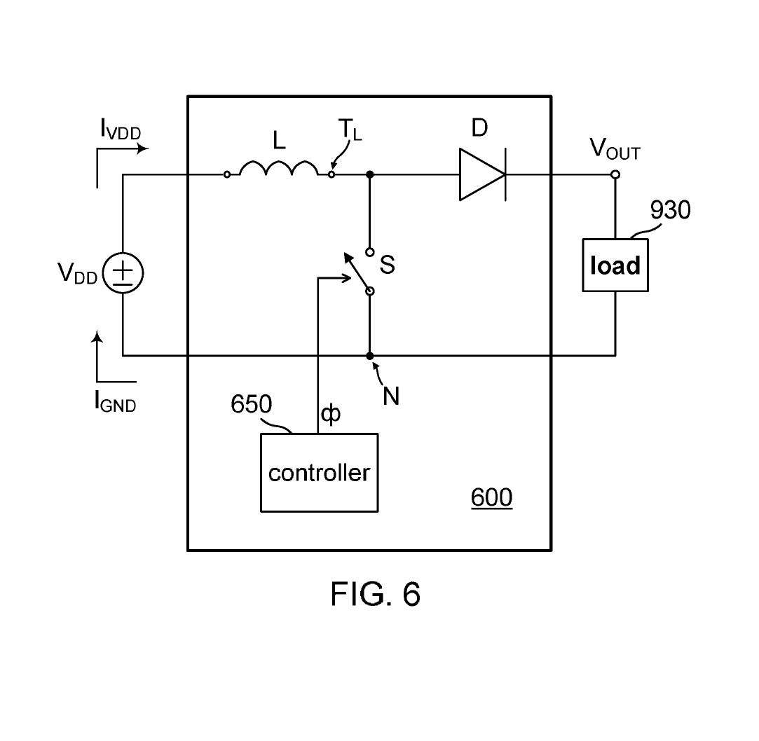

FIG. 6 shows a block diagram of a DC-DC boost converter according to another embodiment of the present invention. A boost converter 600 includes an energy storage component (an inductor L), a switch S, a diode D and a controller 650. The inductor L includes a switching terminal T_{L}. The switch S is coupled between the switching terminal T_{L} and a circuit node N. The controller 650 is configured to switch the switch S, such that the switching terminal T_{L} is intermittently coupled to the circuit node N. The controller 650 controls a switching time point of the switch S according to a spread spectrum signal Φ. In practice, for example but not limited to, the spread spectrum signal Φ may be generated by any of the circuits in FIG. 3(A) to FIG. 3(C). One person having ordinary skill in the art can understand that, the invention concept of reducing high-frequency EMI by the spread spectrum signal can be applied to switches of various types of switched-mode voltage converters, and is not limited to the boost converter shown in FIG. 6.

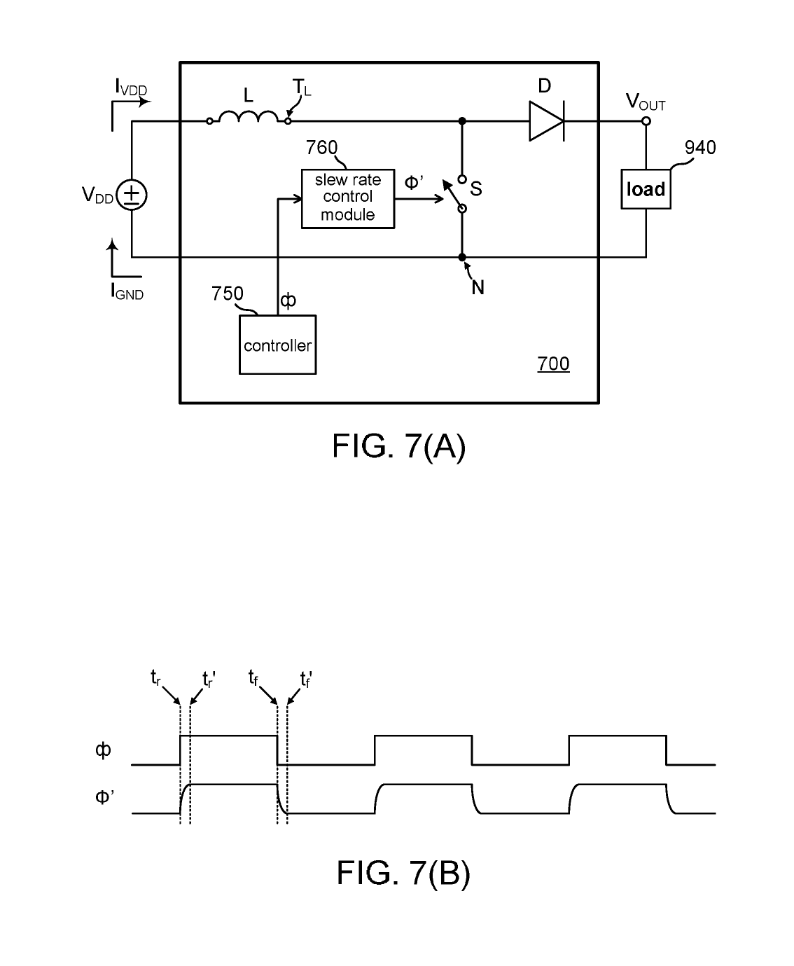

FIG. 7(A) shows a block diagram of a DC-DC boost converter according to another embodiment of the present invention. A boost converter 700 includes an energy storage component (an inductor L), a switch S, a diode D, a controller 750 and a slew rate control module 760. The inductor L includes a switching terminal T_{L}. The switch S is coupled between the switching terminal T_{L} and a circuit node N. The controller 750 provides a control signal Φ to the slew rate control module 760. The slew rate control module 760 is coupled between the switch S and the controller 750, and generates a switch control signal Φ′ according to the control signal Φ, in a way that the switch control signal Φ′ has a lower slew rate compared to the control signal Φ. The switch S is controlled by the switch control signal Φ′, such that the switching terminal T_{L} of the inductor L is intermittently coupled to the circuit node N.

Assume that the switch S is turned on when the switch control signal Φ′ has a high voltage level, and is turned off when the switch control signal Φ′ has a low voltage level. FIG. 7(B) shows an exemplary timing diagram of the control signal Φ and the switch control signal Φ′. In this example, the control signal Φ is substantially a square wave signal. After the rising edge of the control signal Φ appears (at a time point tᵣ), the slew rate control module 760 causes the switch control signal Φ′ to transition from a low voltage level to a high voltage level and the transition substantially completes at a time point tᵣ′. Similarly, after the falling edge of the control signal Φ appears (at time point t_{f}), the slew rate control module 760 causes the switch control signal Φ ′ to transition from a high voltage level to a low voltage level and the transition substantially completes at a time point t_{f}′. As generally known to one person having ordinary skill in the art, compared to the control signal Φ, the switch control signal Φ ′ having a lower slew rate has less high-frequency components. By controlling the switch S with the switch control signal Φ ′, the high-frequency EMI generated from switching the switch S can be reduced. From another perspective, by reducing the slew rate, the current for changing the connecting state of the switch S is distributed to appear in a longer period (e.g., the time point tᵣ to the time point tᵣ′), such that a large instantaneous current change caused by high-frequency EMI can be eliminated. In the above example, the slew rate control module 760 adjusts both the rising edge and the falling edge of signals. However, it should be noted that, the effect of reducing high-frequency EMI can also be achieved by reducing only the slew rate corresponding to the rising edge of signals or by reducing only the slew rate corresponding to the falling edge of signals.

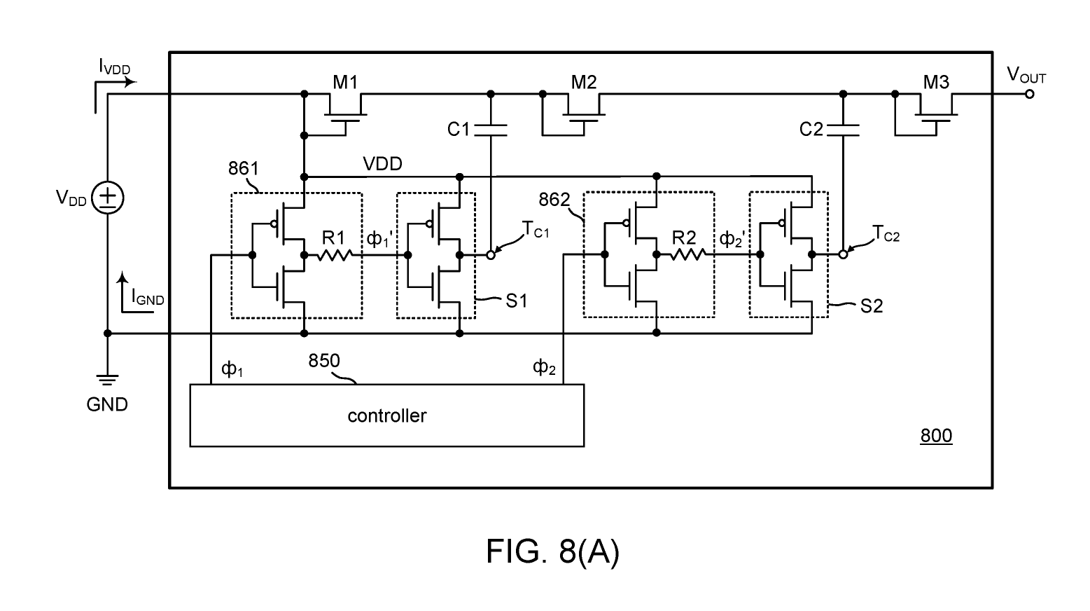

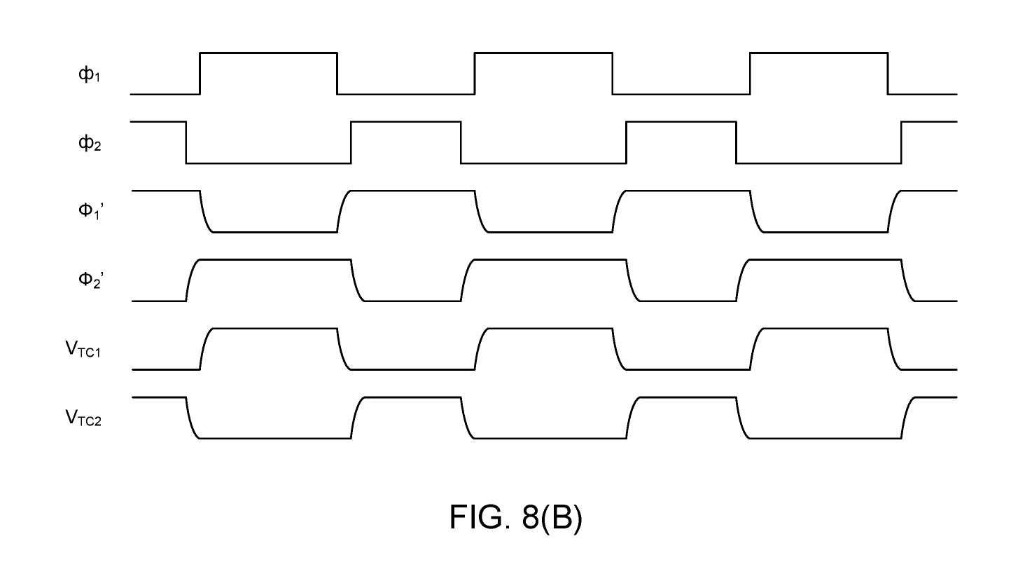

FIG. 8(A) shows a block diagram of another switched-mode boost converter applying the concept of adjusting the slew rate to further illustrate a detailed embodiment of a slew rate control module according to an embodiment of the present invention. Similar to the boost converter 400 in FIG. 4(A), a boost converter 800 also performs boosting by changing connection targets of the switching terminals T_{C1} and T_{C2} to transfer the electric energy in the capacitors C₁ and C₂, such that the boosted voltage V_{OUT} is substantially equal to (3*_{VDD}-3*_{Vth}). In this embodiment, each of the switches S1 and S2 is an inverter, and is implemented by a MOSFET. The switch S1 connects the switching terminal T_{C1} to the ground terminal GND when 1 signal Φ₁′ has a high voltage level, and connects the switching terminal T_{C1} to the power supply terminal VDD when the signal Φ′ has a low voltage level. Similarly, the switching terminal T_{C2} is connected to the ground terminal GND when the signal Φ₂′ has a high voltage level, and is connected to the power supply terminal VDD when the signal Φ₂′ has a low voltage level.

A slew rate control module 861 is coupled between the switch S1 and a controller 850, and includes an inverter implemented by two MOSFETs and a resistor R1. A slew rate control module 862 is coupled between the switch S2 and a controller 850, and includes an inverter implemented by two MOSFETs and a resistor R2. A control signal Φ₁ that the controller 850 generates for the switch S1 is provided to the slew rate control module 861, and a control signal Φ₂ that the controller 850 generates for the switch S2 is provided to the slew rate control module 862. Due to the inverters, switch control signals Φ₁′ and Φ₂′ outputted by the slew rate control modules 861 and 862 are substantially inverted to the control signals Φ₁ and Φ₂. On the other hand, due to the resistors R1 and R2, the slew rates of the switch control signals Φ₁′ and Φ₂′ are lower than the controls signals Φ₁ and Φ₂, respectively. In practice, a circuit designer may adjust the slew rates of the signals Φ₁′ and Φ₂′ by appropriately selecting the sizes of the resistors R1 and R2. FIG. 8(B) shows an exemplary timing diagram of the control signals Φ₁ and Φ₂, the switch control signals Φ₁′ and Φ₂′ and the voltages at the switching terminals T_{C1} and T_{C2}. As previously stated, by controlling the switches S1 and S2 with the switch control signals Φ₁′ and Φ₂′ having lower slew rates, high-frequency EMI generated from switching the switches S1 and S2 can be reduced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A switched-mode voltage converter, comprising:
an energy storage component, coupled a voltage source, comprising a switching terminal;
a plurality of switches, coupled between the switching terminal of the energy storage component and a circuit node; and
a controller, that switches the plurality of switches, such that the switching terminal of the energy storage component is intermittently coupled to the circuit node;
wherein, the controller controls the plurality of switches to switch from a first connecting state to a second connecting state at different time points.

2. The switched-mode voltage converter according to claim 1, wherein a current driving capability of each of the plurality of switches is lower than a predetermined threshold.

3. The switched-mode voltage converter according to claim 1, wherein the controller further controls the plurality of switches to switch from the second connecting state to the first connecting state at different time points.

4. The switched-mode voltage converter according to claim 1, wherein current driving capabilities of the plurality of switches are different.

5. The switched-mode voltage converter according to claim 1, wherein the energy storage component is selected from a group consisting of a capacitor and an inductor.

6. The switched-mode voltage converter according to claim 1, wherein the controller comprises a delay component that receives a control signal and outputs a delayed control signal; the controller outputs the control signal to control a first switch of the plurality of switches, and outputs the delayed control signal to control a second switch of the plurality of switches.

7. The switched-mode voltage converter according to claim 1, wherein the controller controls at least one switch of the plurality of switches by a spread spectrum signal.

8. The switched-mode voltage converter according to claim 7, wherein a modulation period, a frequency hopping rule or a degree of spread spectrum of the spread spectrum signal changes with time.

9. A switched-mode voltage converter, comprising:
an energy storage component, coupled to a voltage source, comprising a switching terminal;
a switch, coupled between the switching terminal of the energy storage component and a circuit node; and
a controller, that switches the switch, such that switching terminal of the energy storage component is intermittently coupled to the circuit node;
wherein, the controller outputs a spread spectrum signal to control switching of the switch.

10. The switched-mode voltage converter according to claim 9, wherein a modulation period, a frequency hopping rule or a degree of spread spectrum of the spread spectrum signal changes with time.

11. A switched-mode voltage converter, comprising:
an energy storage component, coupled to a voltage source, comprising a switching terminal;
a switch, coupled between the switching terminal of the energy storage component and a circuit node; and
a controller, generating a control signal for the switch; and
a slew rate control module, coupled between the switch and the controller, generating a switch control signal according to the control signal, such that the switch control signal has a lower slew rate compared to the control signal;
wherein, the switch is controlled by the switch control signal, such that the energy storage component is intermittently coupled to the circuit node.

12. The switched-mode voltage converter according to claim 11, wherein
the slew rate control module comprises:
an inverter, comprising an input end and an output end, the input end receiving the control signal from the controller; and
a resistor, comprising a first node and a second node, the first node coupled to the output end of the inverter, the second node coupled to the switch; wherein, a voltage provided by the second node is the switch control signal.
